(19) United States
(12) Patent Application Publication
(10) Pub. No.: US 2014/0237330 A1
(43) Pub. Date: Aug. 21, 2014

(54) Memoir Writing

(71) Applicants: James Montgomery Pitzner, Maple Grove, MN (US); Elizabeth Hilton, Galesville, WI (US); William Routhier, Salem, MA (US); Smitaben I. Giesen, Maple Grove, MN (US)

(72) Inventors: James Montgomery Pitzner, Maple Grove, MN (US); Elizabeth Hilton, Galesville, WI (US); William Routhier, Salem, MA (US); Smitaben I. Giesen, Maple Grove, MN (US)

(21) Appl. No.: 13/773,238

(22) Filed: Feb. 21, 2013

(51) Int. Cl. G06F 17/21

(52) U.S. Cl. CPC G06F 17/21
USPC 715/202

(57) ABSTRACT

A system for creating a memoir includes: a physical memory; and a processing unit executing instructions stored on the physical memory to perform the following steps: receiving a request from a user to create the memoir; obtaining information about a subject for the memoir; assigning writing of the memoir to a writer; receiving and distributing drafts of the memoir; and presenting the memoir to the user.

### BACKGROUND

Time moves quickly, particularly as one grows older. This acceleration is exacerbated by the proliferation of electronics, which makes the speed at which “life” moves even quicker. As a person grows, certain milestones are celebrated, such as school graduations, marriage, children, etc. Typically, the individual and loved ones attempt to commemorate these celebrations by taking pictures. However, unless the individual is highly motivated, the pictures typically sit in a shoebox under the bed or, more recently, are stored on a computer hard drive along with hundreds of other photos that are rarely or ever revisited. One therefore cannot easily enjoy or reflect upon these special life events.

### SUMMARY

In one aspect, a system for creating a memoir includes: a physical memory; and a processing unit executing instructions stored on the physical memory to perform the following steps: receiving a request from a user to create the memoir; obtaining information about a subject for the memoir; assigning writing of the memoir to a writer; receiving and distributing drafts of the memoir; and presenting the memoir to the user.

In another aspect, a method for drafting a memoir includes: receiving, using a computing device, a request from an entity to create the memoir from a user; obtaining information about a subject for the memoir; assigning writing of the memoir to a writer; receiving and distributing, by the computing device, drafts of the memoir; and presenting the memoir to the user.

In yet another aspect, a method for drafting a memoir includes: receiving, using a computing device, a request from an entity to create the memoir from a user, the request including answers to a questionnaire that collects standard information from the user; obtaining information about a subject for the memoir, including receiving photographs and other information from the user; assigning writing of the memoir to a writer; providing guidelines to the writer for writing the memoir; setting a schedule for the writer to follow as the writer writes the memoir, including requiring a certain number of words to be created each week of the schedule; conducting interviews regarding the subject of the memoir; receiving and distributing, by the computing device, drafts of the memoir; allowing the user to customize a book encapsulating the memoir; and presenting the memoir to the user.

### DESCRIPTION OF THE DRAWINGS

FIG. 1 shows an example system that supports the creation of a memoir.

FIG. 2 shows example individuals whom are involved in the creation of the memoir using the system of FIG. 1.

FIG. 3 shows an example method for creating the memoir using the system of Figure

FIG. 4 shows an example method for gathering information for the memoir using the system of FIG. 1.

FIG. 5 shows an example method for drafting the memoir using the system of FIG. 1.

FIG. 6 shows an example timeline for drafting the memoir using the system of FIG. 1.

FIG. 7 shows an example computing device of the system of FIG. 1.

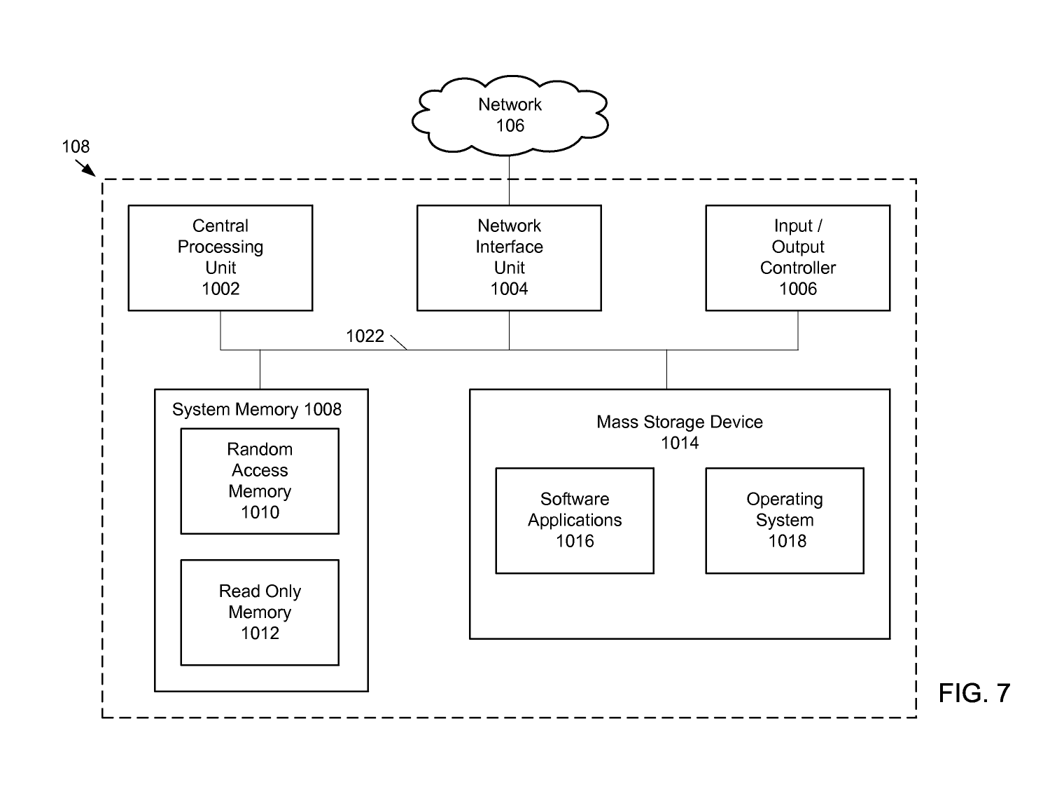

### DETAILED DESCRIPTION

The present disclosure is directed to systems and methods for writing memoirs. In examples explained herein, the systems and methods are configured to provide a consistent process to capture certain life experiences in a written and/or electronic format. The example memoirs can take different forms, as described further below.

In example embodiments, the resulting memoirs have a novelistic style, with personal facts and history written in a literary narrative that will instill the reader with certain memories. It can be biographical, but personalized, so it is in a tone like a memoir. While the memoir is typically nonfiction-based, elements of novel writing are used in a way that makes the life of the subject readable, employing such elements as excitement, drama, and poignancy.

Various subjects can be used for the memoir. In some examples, the memoirs capture a particular event in life, such as a marriage. In other examples, the memoir focuses more on the totality of the life or one or more protagonists. For example, the memoir can tell the story of a person, couple, family, or business. The resulting memoir, in hardcopy and/or electronic formats, captures the event or life, using facts along with interesting writing style and other materials (e.g., historical facts, photographs etc.) to allow the reader to relive the past event(s).

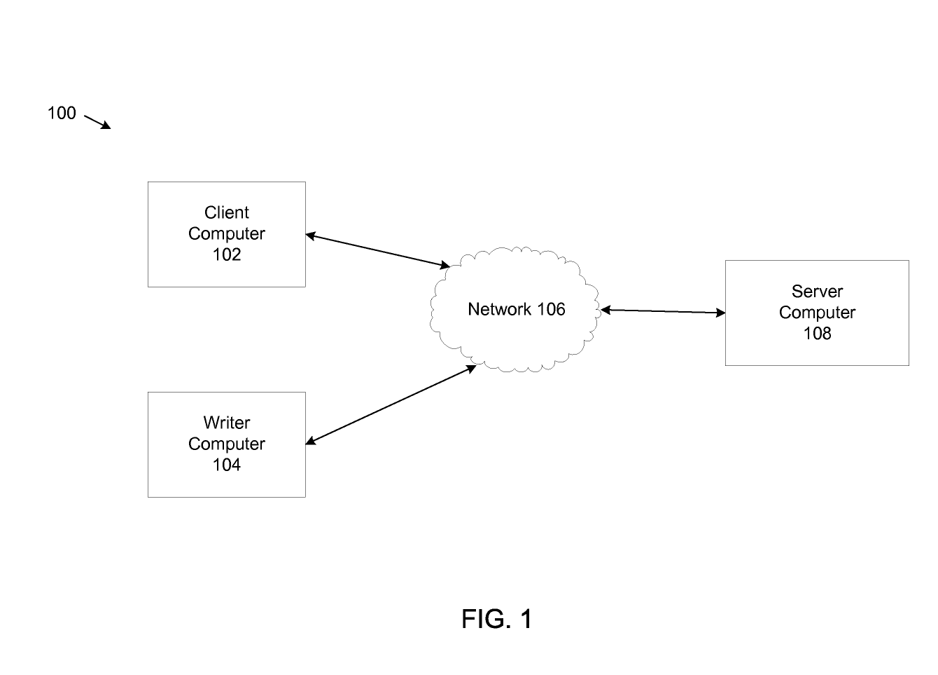

Referring now to FIG. 1, an example system 100 is shown that is configured to allow for the creation of a memoir. The system 100 includes a client computer 102, a writer computer 104, a network 106 and a server computer 108. Examples of the client computer 102 and the writer computer 104 are a desktop computer, a laptop computer, or a mobile computing device like a cellular telephone or a tablet computer. An example of server computer 108 is a web server computer. More than one client computer 102, writer computer 104 or server computer 108 may be used. Typically, network 106 is the Internet.

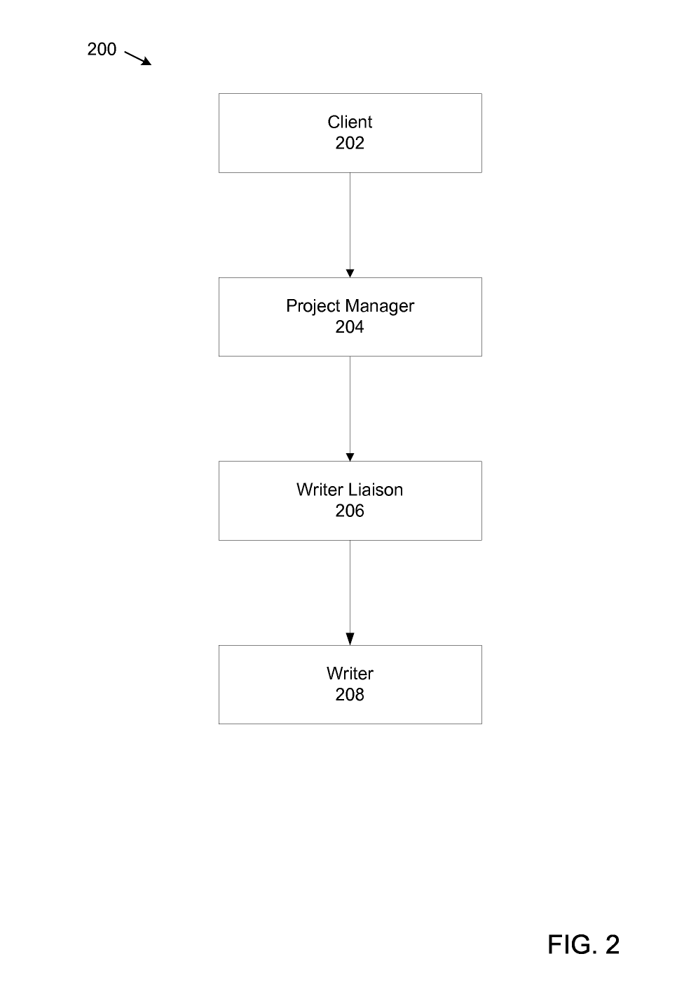

In some examples, various individuals use the client computer 102, the writer computer, and the server computer 108 to assist in the creation of the memoir. As shown in FIG. 2, individuals 200 that are involved in the creation of the memoir include a client 202, a project manager 204, a writer liaison 206, and a writer 208.

The client 202 is the individual, group, and/or entity that commissions the memoir to be written. In this example, the client computer 102 is used by the client 202 to request the memoir, provide information for the memoir, and to review the memoir. For example, the client computer 102 can be used to access a web site hosted on the server computer 108 using a web browser. On that web site, the client 202 can request that a memoir be written, as well as provide information for the memoir. In addition, the client 202 can pay for the service and receive information about the memoir from the server computer 108.

The project manager 204 facilitates the process used to create the memoir. In some examples, the project manager 204 manages deadlines and is the primary interface between the client 202 and the writers used to draft the memoir. For example, the project manager 204 communicates with the client 202 through email or telephone to collect information needed to prepare the memoir.

The writer liaison 206 and the writer 208 actually write the memoir based upon information provided by the client 202. In one example, the writer liaison 206 is an editor that tracks deadlines and revises the memoir. The writer 208 is the individual that gathers facts and actually writes the first draft and revisions of the memoir.

The writer computer 104 is used by the writer 208 to facilitate the writing of the memoir. For example, the writer 208 can use the writer computer 104 to access information from the server computer 108, like information about the client 202 (e.g., biographical information, photographs, etc.). The writer computer 104 can also be used to draft the memoir, using word processing software like Microsoft Word from Microsoft Corporation of Redmond, Wash. Further, the writer computer 104 can be used by the writer 208 to communicate with the client 202 and the writer liaison 206 to, for example, submit drafts of the memoir for review.

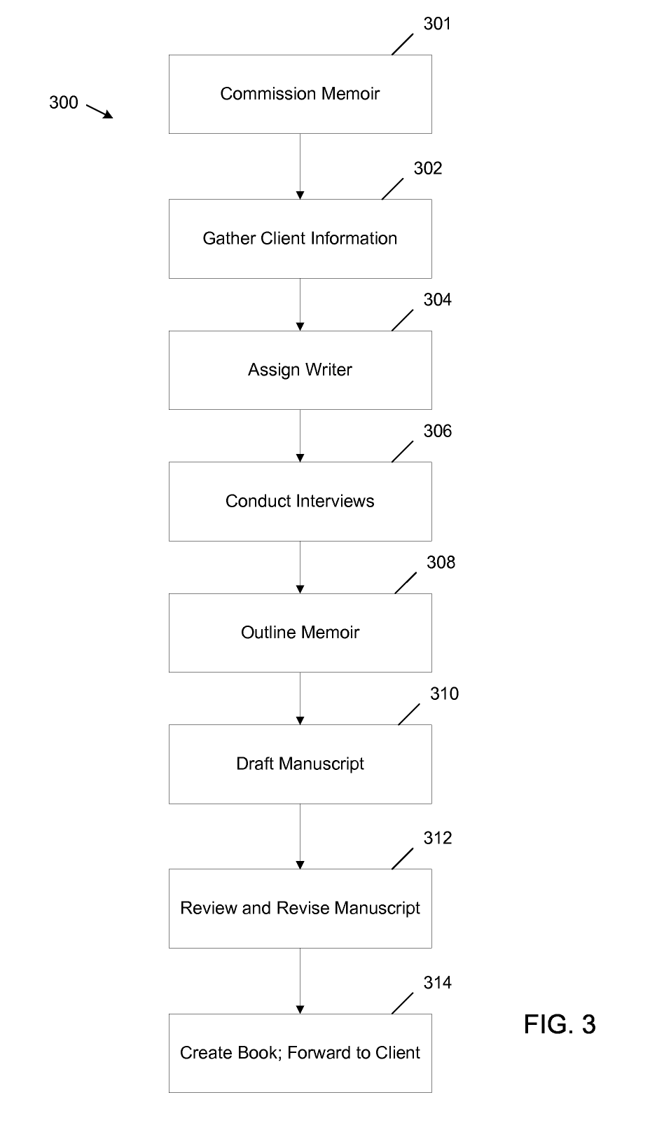

Referring now to FIG. 3, an example method 300 for creating the memoir is shown. Various steps of the method 300 are performed by the client 202, project manager 204, writer liaison 206, and writer 208.

Initially, at step 301, the client 202 commissions the memoir. This can be accomplished, for example, by accessing information about the process on a web site hosted on the server computer 108. This information can include the type of memoir desired (e.g., personal—focusing on the life of one individual; couple—focusing on the lives of two individuals; family—focusing on the lives of a family; business—focusing on the history of a venture; etc.), amount of services requested (e.g., breadth of subject of memoir, external research required, and interior and exterior features of memoir), type of memoir binding (e.g., various themes can be used to define the binding of the memoir, such as: classical—bound in classic colors; landscape—bound in landscape orientation; colonial—in American colonial style; naturist—with clean lines), size and other features of the memoir, and/or pricing information.

Next, after the desired memoir is selected, information about the client 202 is gathered at step 302. This can include payment information (e.g., a retainer or full amount for services rendered can be collected). Other information can also be gathered about the memoir.

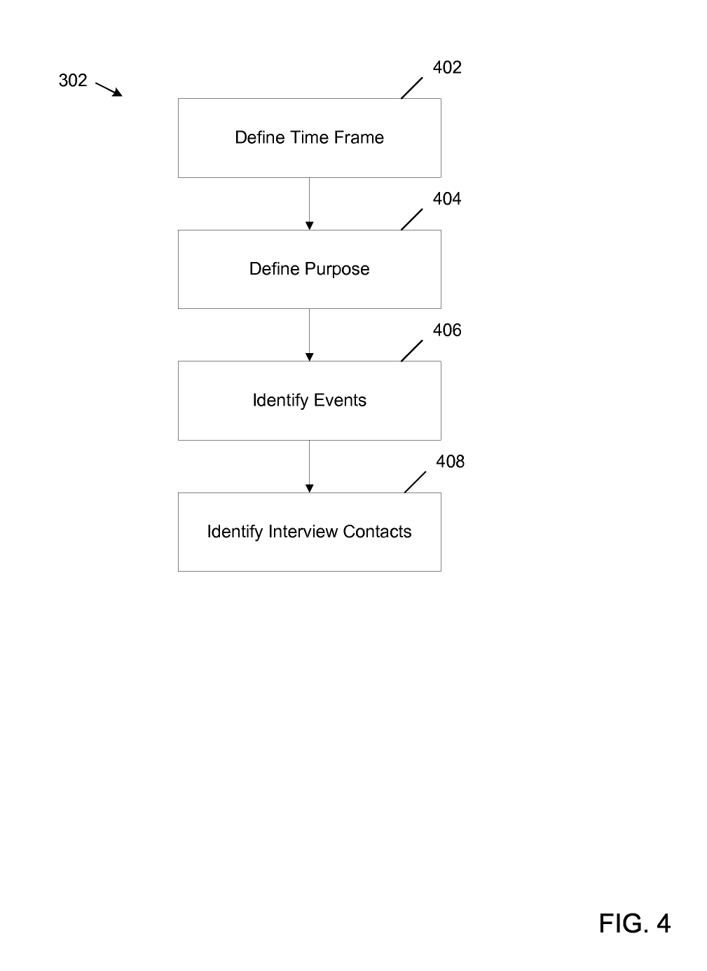

For example, referring to FIG. 4, the client 202 completes an information sheet that gathers information needed to write the memoir. This information can be communicated electronically to the server computer 108, or the client 202 can fill out a hardcopy information packet.

As part of this process, at step 402, information about the desired time frame for the memoir is identified, such as an entire life or specific years to be explored. In another example, a specific major event (e.g., marriage, child, etc.) can be selected, and information about that event is provided.

Next, at step 404, the purpose of the memoir is defined by the client 202. For example, the purpose can be to commemorate a person or specific event. In addition, the predicted use of the memoir is provided, such as private (used privately by a set of individuals), heirloom (used for a particular family), or for sharing with others, such as family and/or friends. Further, such information as the main premise or theme for the memoir is provided, along with special circumstances, like whether or not the memoir is gift for someone else. Finally, information about certain events to avoid is also provided.

Next, at step 406, the relevant events for the memoir are identified. This is provided in a chronology that assists in the writing of the memoir. Examples of such events include date of birth, schools attended, jobs worked, places lived, marriage, and birth of children, as well as dates associated with each. Specific events can be identified as most significant or life-changing, so that special attention is provided to them. Further, topics such as unfulfilled ambitions and key memories can also be explored.

Finally, at step 408, the client 202 identifies contacts to be interviewed for the memoir. The contacts list can be provided in order of importance, and the list can include both contact names, relationship to the client, and contact information (e.g., telephone number and email address). As described further below, the writer 208 can use these contacts to gather information for the memoir.

Referring back to FIG. 3, once the client 202 submits this information, the project manager 204 reviews the information and assigns a writer at step 304. This process can include selecting a writer from a given talent pool (e.g., some writers may specialize in particular types of writing styles), availability, etc.

In some examples, the writers are given a test to determine competency. This test can be standardized so that the skills of each writer can be objectively compared to other writers. In one example, each writer is provided with basic client information about a memoir and asked to write a portion or the entire memoir. The resulting writing is then analyzed to determine competency. Those writers showing a requisite skill set are added to the list of writers that are available to write memoirs for the system 100.

The selected writer 208 and writer liaison 206 are notified of the memoir and are provided with materials about the client 202. Again, such material can be accessed using the writer computer 104.

For example, the client 202 can use the client computer 102 to access a personal portal hosted on the server computer 108 once the memoir is commissioned. As described further below, the client 202 uses the portal to review drafts, as well as provide information about the memoir. The client 202 can, for example, upload pictures, letters, keepsakes, and other information that is germane to the memoir. The writer 208 uses the writer computer 104 to access the uploaded information from the server computer 108 during preparation of the memoir.

At step 306, the writer 208 conducts interviews with the contacts provided by the client 202. For example, if the memoir is about a wedding, the writer 208 may interview the bride and groom, as well as others associated with the wedding, such as the best man and woman, family, and/or attendees.

This is accomplished by the writer 208 contacting each individual based upon the information provided by the client 202. In some examples, a form email or script is provided that streamlines the communications between the writer 208 and the interviewees. The writer 208 schedules a period of time (e.g., 1-2 hours) with each contact to conduct the interview. In some examples, the interviews are recorded and transmitted to the server computer 108 for storage.

In some examples, the interviews are conducted in person. In others, the interviews are conducted by telephone or video conference. For example, in one embodiment, the interviews are conducted online using a service such as Skype, and the interviews are captured as they are conducted on the writer computer 104.

During the interviews, the writer 208 follows a specific sequence for each interview. For example, the interviews can be done based upon the importance of each individual as ranked by the client 202. Generally, the interviews are conducted in the order from the individual with the most information on down to the individual with the least information. For example, if the memoir is about a grandfather's life, the grandfather would be interviewed first, then the grandfather's son, since the son is likely to have the most pertinent information. This allows the writer 208 to assess the information obtained after each interview and to plan future interviews to obtain needed information.

During each interview, the writer 208 asks questions that will assist the writer 208 in writing the memoir. These questions will be specific to the type of memoir that is being written. Typically, these questions are prepared in advance by the writer 208, although the writer 208 is prepared to follow-up on questions as the interview progresses to obtain information.

The interview is conducted in a conversational manner so that a maximum amount of information is obtained. Important information, such as the correct spellings of names and places, is emphasized so that the memoir is accurate when written. In addition, a time at the end of each interview is provided so that the interviewee can add any personal or philosophical statements about the subject of the memoir. For example, for the grandfather's memoir, the son is given the opportunity to express what his grandfather has meant to him over the years. This is typically accomplished using open-ended questions.

In one example, one or more of the interviews are transcribed, and the content (e.g., audio and/or transcription) is stored on the server computer 108.

Next, at step 308, the writer 208 is tasked with outlining the contents of the memoir. This process assures that the memoir is complete, and the writer 208 can be required to work with the writer liaison 206 to assure that the scope of the memoir, as defined by the outline, is agreed upon before the writing begins.

Once the outline is finalized, the writer 208 begins writing the memoir at steps 310 and 312. In some examples, the writing process is broken into specified segments with specified review so that the entire process of writing the memoir is standardized.

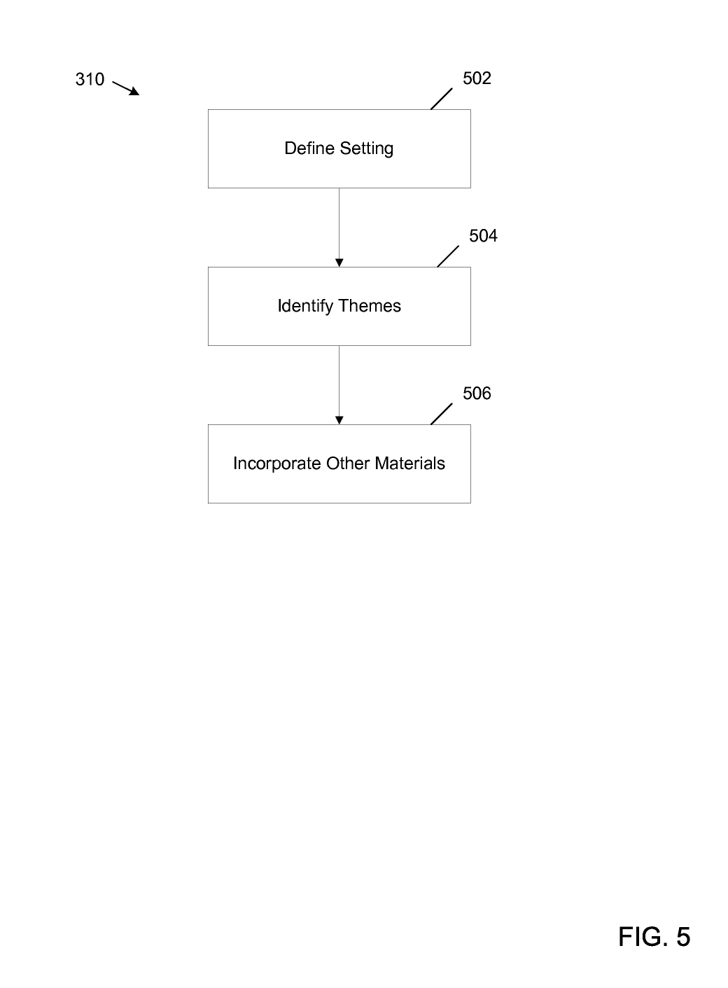

For example, as shown in FIG. 5, the writer 208 begins writing the memoir by defining certain aspects of the memoir.

These aspects can include defining the setting for the memoir at step 502. The setting is important in establishing a sense of place in the memoir. This can be important to the client 202, since place always has a lasting significance in one's personal story. At times, the writer 208 researches beyond what information is provided by the client 202 to develop the setting, such as place of birth or where the protagonist lived.

In addition, the writer 208 identifies themes at step 504. The themes typically come out of the interview process and highlight a characteristic or several characteristics of the memoir's subject. For instance, if the memoir is about adversity over difficult circumstances, this would be the main theme of the memoir. A secondary theme would be that, in each circumstance where the subject seemed to be close to defeat, some person or circumstance seemed to come at the right time to the memoir subject's aid. Another theme might be the subject's interest in a particular avocation or hobby, such as becoming a pilot, or a mountain climber, which, though separate from their work-day existence, had a large impact on their life. The theme and subthemes are developed by the writer 208 prior to writing the memoir.

Further, the writer 208 manages and incorporates materials into the memoir at step 506. Examples of such materials include photographs, letters, wedding and birth announcements, etc. This material can be incorporated as a featured part of the memoir when completed.

In one alternative example, the writer 208 uses the writer computer 104 to assist in incorporating materials. For example, if a large corpus of electronic photographs is provided by the client 102, the writer 208 can use automated and/or manual facial tagging to identify certain pictures for inclusion in the memoir. If the writer 208 is writing a memoir about a family, the writer 208 can conduct one or more queries on the writer computer 104 to automatically identify photographs of the family for inclusion in the memoir. In some examples, the facial recognition is manual, allowing the client 202 and/or the writer 208 to tag people shown in each photograph. In another example, automated facial recognition software is used to automatically identify the people in each photograph.

In addition, the writer 208 can conduct follow-up interviews as necessary to gather additional information. For example, when preparing the outline, the writer 208 may realize that additional information about a particular subject is needed. If this is the case, the writer 208 can contact the appropriate interviewees to follow-up to obtain the needed information.

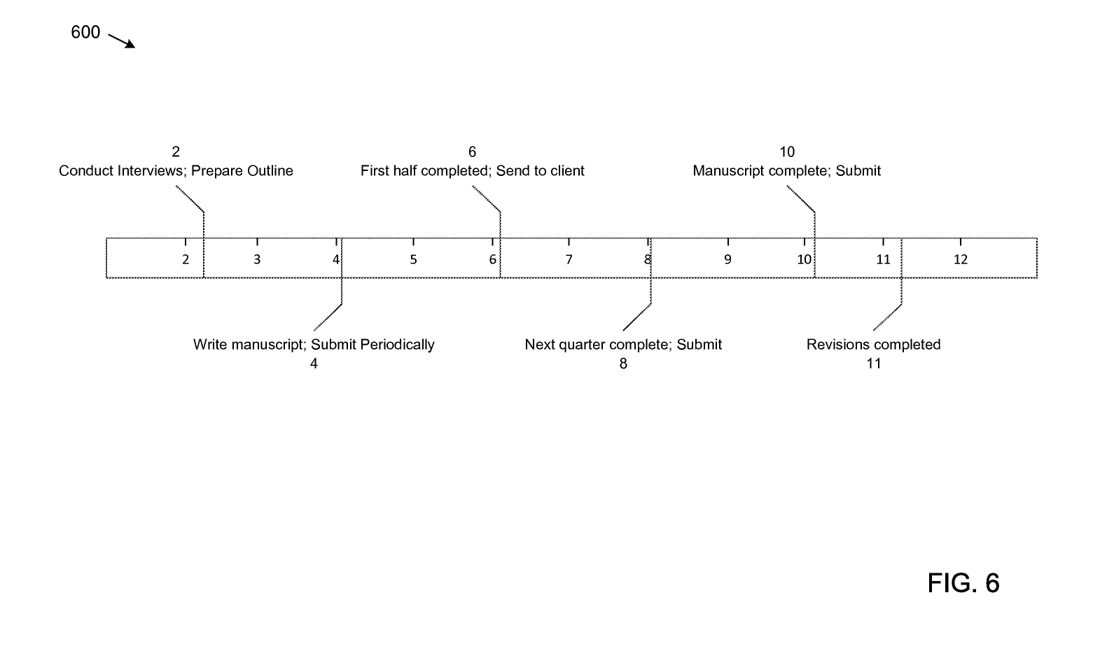

Referring to FIG. 6, a timeline 600 is used to prepare the memoir. This timeline 600 assures that the memoir is prepared in a timely fashion and according to reproducible results.

According to the timeline 600, a length of 12 weeks is provided to write the memoir. More or less time can be provided, as needed, depending on the project. The timeline 600 is utilized to enhance performance and consistency across the different memoirs that are prepared.

In one example, the timeline 600 is implemented on the host computer 108 so that an automated system is used to track the milestones on the timeline 600. For example, in one embodiment, project tracking software, such as SharePoint 2013 and Project 2013 from Microsoft Corporation of Redmond, Wash., is used. Other configurations are possible.

During the first two weeks of the timeline 600, the writer 208 conducts interviews, compiles notes, and prepare the outline. The writer 208 provides the interview information (e.g., audio files and/or transcripts) and outline to the writer liaison 206. As previously noted, the writer liaison 206 approves the outline prior to work beginning on the writing of the memoir.

At approximately four weeks, the writer 208 completes a first section of the memoir and sends the completed section to the writer liaison 206 for review. In some examples, each milestone requires a specific number of words to be completed, such as 1000 words a day or 5000 words a week. As each section is completed, it is communicated (e.g., by email) to the writer liaison 206. The writer liaison 206 checks the quality of the work and discusses any issues with the writer 208 so that the memoir stays on course.

The writer liaison 206 continues to review sections as provided each day and/or week. At six weeks, the writer 208 completes the first half of the memoir. At this time, the first half of the memoir is communicated to the client 202. The client 202 is thereupon able to provide feedback. Typically, the feedback is in the form of factual revisions, rather than stylistic revisions.

At week eight, the memoir is three-quarters complete, and the process of writing and review continues. At week ten, the memoir is complete, typically including approximately 40,000-45,000 words, although the length can vary by project. The writer liaison 206 reviews the work, and any final edits are made. The second half of the memoir can also be communicated to the client 202 for factual review.

At week eleven, the complete memoir is communicated to the client 202 for a final factual review. The writer 208 and writer liaison 206 make any final changes to the memoir at this time, and the memoir can be formatted for printing.

Referring back to FIG. 3, finally the memoir is completed at step 314. This includes any final formatting, as well as binding of the memoir. The memoir is delivered to the client 202, and electronic copies of the memoir (if provided) can be accessed from the server computer 108. In some examples, multiple copies can be provided, and each copy can be individualized depending on the audience. For example, the cover can be changed depending on to whom the memoir is being given.

Although the example described above relates to a memoir, other types of writings can also be done. In another example, the writing relates to a particular event, such as a wedding. As noted above, such a memoir would focus on the two individuals getting married, and the interviews and thrust of the memoir would be tailored accordingly. The process for preparing such a memoir would be similar to that provided above.

In such an example, ancillary information and products can be provided in addition to the memoir commemorating the event. In some examples, such products include mementos like the printed wedding invitation, memorialized wedding vows, etc.

Many or all of the tasks associated with the preparation of the memoir described above are tied to the computers and technology described herein. For example, the overall process can be tracked and facilitated by the host computer 108, as described above. The interviews can be conducted and captured using the technology described herein. Finally, the writing, formatting, and presentation of the memoir can be done electronically. In some examples, the memoir is delivered in an electronic format, being hosted on the host computer 108 for access by the client. This technology is integral to the efficiency and consistency of the process.

There are various advantages to the systems and methods described herein. One advantage of the methods described above is that the subjective process of writing a memoir is standardized, so that memoirs can be created for many clients using a predictable, repeatable, and scalable process. In this manner, the system can be scaled (increased or decreased) depending on demand. For example, if more memoirs are requested, additional writers can be retained. Because of the standardized process and review, the work product from these additional writings will conform to the other memoirs prepared by other writers to that a consistent product is delivered to each client.

FIG. 10 illustrates example physical components of the server computer 108. The description of the physical components of server computer 108 herein also applies to client computer 102 and writer computer 104.

As illustrated in the example of FIG. 10, the server computer 108 is a computing device that includes at least one central processing unit (“CPU”) 1002, a system memory 1008, and a system bus 1022 that couples the system memory 1008 to the CPU 1002. The system memory 1008 includes a random access memory (“RAM”) 1010 and a read-only memory (“ROM”) 1012. A basic input/output system contains the basic routines that help to transfer information between elements within the server computer 108, such as during startup, is stored in the ROM 1012. The server computer 108 further includes a mass storage device 1014. The mass storage device 1014 is able to store software instructions and data.

The mass storage device 1014 is connected to the CPU 1002 through a mass storage controller (not shown) connected to the system bus 1022. The mass storage device 1014 and its associated computer-readable data storage media provide non-volatile, non-transitory storage for the server computer 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 108.

According to various embodiments of the invention, the server computer 108 may operate in a networked environment using logical connections to remote network devices through the network 106, such as a local network, the Internet, or another type of network. The server computer 108 may connect to the network 106 through a network interface unit 1004 connected to the system bus 1022. It should be appreciated that the network interface unit 1004 may also be utilized to connect to other types of networks and remote computing systems. The server computer 108 also includes an input/output controller 1006 for receiving and processing input from a number of other devices, including a keyboard, a mouse, a touch user interface display screen, or another type of input device. Similarly, the input/output controller 1006 may provide output to a touch user interface display screen, a printer, or other type of output device.

As mentioned briefly above, the mass storage device 1014 and the RAM 1010 of the server computer 108 can store software instructions and data. The software instructions include an operating system 1018 suitable for controlling the operation of the server computer 108. The mass storage device 1014 and/or the RAM 1010 also store software instructions, that when executed by the CPU 1002, cause the server computer 108 to provide the functionality of the server computer 108 discussed in this document. For example, the mass storage device 1014 and/or the RAM 1010 can store software instructions that, when executed by the CPU 1002, cause the server computer 108 to display received physiological data on the display screen of the server computer 108.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A system for creating a memoir, the system comprising:
a physical memory; and
a processing unit executing instructions stored on the physical memory to perform the following steps:
receiving a request from a user to create the memoir;
obtaining information about a subject for the memoir;
assigning writing of the memoir to a writer;
receiving and distributing drafts of the memoir; and
presenting the memoir to the user.

2. The system of claim 1, further comprising receiving photographs and other information from the user.

3. The system of claim 1, further comprising allowing the writer to conduct interviews regarding the subject of the memoir.

4. The system of claim 3, further comprising storing recordings of the interviews.

5. The system of claim 1, further comprising facilitating testing of a plurality of writers to select the writer for the memoir.

6. The system of claim 1, wherein the information about the subject includes a questionnaire that collects standard information from the user.

7. The system of claim 1, further comprising allowing the user to customize a book encapsulating the memoir.

8. The system of claim 1, further comprising providing guidelines to the writer for writing the memoir.

9. The system of claim 8, further comprising setting a schedule for the writer to follow as the writer writes the memoir.

10. A method for drafting a memoir, comprising:
receiving, using a computing device, a request from an entity to create the memoir from a user;
obtaining information about a subject for the memoir;
assigning writing of the memoir to a writer;
receiving and distributing, by the computing device, drafts of the memoir; and
presenting the memoir to the user.

11. The method of claim 10, further comprising receiving photographs and other information from the user.

12. The method of claim 10, further comprising facilitating information to allow the writer to conduct interviews regarding the subject of the memoir.

13. The method of claim 12, further comprising storing recordings of the interviews.

14. The method of claim 10, further comprising facilitating testing of a plurality of writers to select the writer for the memoir.

15. The method of claim 10, wherein the information about the subject includes a questionnaire that collects standard information from the user.

16. The method of claim 10, further comprising allowing the user to customize a book encapsulating the memoir.

17. The method of claim 10, further comprising providing guidelines to the writer for writing the memoir.

18. The method of claim 17, further comprising setting a schedule for the writer to follow as the writer writes the memoir.

19. A method for drafting a memoir, comprising:
receiving, using a computing device, a request from an entity to create the memoir from a user, the request including answers to a questionnaire that collects standard information from the user;
obtaining information about a subject for the memoir, including receiving photographs and other information from the user;
assigning writing of the memoir to a writer;
providing guidelines to the writer for writing the memoir;
setting a schedule for the writer to follow as the writer writes the memoir, including requiring a certain number of words to be created each week of the schedule;
conducting interviews regarding the subject of the memoir;
receiving and distributing, by the computing device, drafts of the memoir;
allowing the user to customize a book encapsulating the memoir; and
presenting the memoir to the user.

20. The method of claim 19, further comprising automatically identifying individuals in photographs for inclusion by the writer in the memoir.
